(19) United States
(12) Patent Application Publication
(10) Pub. No.: US 2008/0131242 A1
(43) Pub. Date: Jun. 5, 2008

(54) Grain bin discharge guard and power sweep

(76) Inventors: Thomas John Duffy, Osceola, IN (US); Floyd Allen Fitch, Goshen, IN (US)

Correspondence Address: HARNESS, DICKEY & PIERCE, P.L.C., P.O. BOX 828, BLOOMFIELD HILLS, MI, 48303, US

(21) Appl. No.: 11/973,646

(22) Filed: Oct. 9, 2007

Related U.S. Application Data
(60) Provisional application No. 60/849,872, filed on Oct. 9, 2006.

(51) Int. Cl. B65G 29/00

(52) U.S. Cl. 414/311; 414/310; 414/808

(57) ABSTRACT

An apparatus adapted to be rotatably mounted proximate a discharge opening of a grain bin can include a guard. The guard can have a plurality of knife units having a plurality of spaced apart blades having grain engaging cutting edges for cutting and breaking up compacted grain. A sweep portion can include an auger rotatably driven about an auger axis by a motor. The sweep portion can be arranged substantially parallel and proximate to a floor of the grain bin. Rotation of the auger can urge grain to move toward the discharge opening. A mounting assembly can be adapted to operably couple the guard and the sweep portion such that the guard and the sweep portion rotate concurrently about the floor of the grain bin.

### CROSS-REFERENCE TO RELATED APPLICATIONS

This application claims the benefit of U.S. Provisional Patent Application No. 60/849,872, filed on Oct. 9, 2006, the disclosure of which is incorporated herein by reference.

### FIELD

This invention relates generally to grain bins, and more particularly, to grain bins having a discharge opening and a power sweep auger to facilitate movement of grain to the discharge opening.

### BACKGROUND

Bins for storing grain commonly take the form of covered shelters. In one arrangement, a sump or center well may be provided below a discharge opening in the center of the bin floor. As a result, when grain is drawn from the bin, the grain flows through the discharge opening by gravity feed into the center well. Typically, an auger conveyor or the like is positioned below the floor of the grain storage bin in communication with the center well. The auger receives the grain passing through the discharge opening and conveys the same to a point of utilization external to the bin.

In many cases, grain may be stored in such bins for a considerable period of time. After long storage, some of the grain can form large chunks of compacted grain. As grain is removed from the bin, these chunks of grain can bridge across the discharge opening and thus form a blockage in or over the bin center well. As a result, grain removal from the center well by the auger conveyor can be hampered or in some cases totally impeded.

It is also common practice to periodically completely empty such grain bins. In one example, a sweep auger may be introduced into the bin with its discharge end over the discharge opening. As the sweep auger sweeps across the floor of the grain bin, it conveys the grain within the bin to the discharge opening and the center well. The grain is then conveyed from the bin by the auger conveyor below the floor in communication with the center well, thereby making it possible to empty the bin.

It would be desirable to provide a guard apparatus for the discharge opening of a grain bin which encourages free flow of the grain to and through the opening while also cooperating with a dynamic sweep auger.

### SUMMARY

An apparatus for use in association with a discharge opening that is centrally located in a circular floor of a grain bin is disclosed. The apparatus can include a sweep auger configured to be rotatably driven about an auger axis that is substantially horizontal when the sweep auger is arranged substantially parallel and proximate to a floor of the grain bin. Rotation of the auger about the auger axis urges grain to move toward the discharge opening. The sweep auger can also be configured to be rotatably driven about a substantially vertical sweep axis proximate to the discharge opening. A guard can be included having an upper boundary structure. The guard can be configured to position the upper boundary structure above the discharge end of the sweep auger and above the discharge opening of the grain bin. The upper boundary structure can be configured to restrict a generally downward flow of compacted grain to the discharge opening of the grain bin, thereby reducing the possibility that compacted grain might block the discharge opening.

An apparatus for moving grain in a grain bin to a discharge opening that is centrally located in a circular floor of the grain bin is also disclosed. The apparatus can include a sweep auger arranged substantially parallel and proximate to a floor of the grain bin. The sweep auger can be rotatably driven about an auger axis. The auger axis can be substantially horizontal, wherein rotation of the sweep auger about the auger axis urges grain to move toward the discharge opening. The sweep auger can also be rotatably driven about a sweep axis proximate to the discharge opening, the sweep axis being substantially vertical. A guard can be coupled to the sweep auger to cause the guard and the sweep auger to rotate concurrently about the substantially vertical sweep axis. The guard can have an upper boundary structure and the upper boundary structure can be positioned above the discharge end of the sweep auger and above the discharge opening of the grain bin. The upper boundary structure can include a plurality of knife edges to break up at least some of a downward flow of compacted grain contacting the boundary structure as compacted grain moves to the discharge opening, thereby reducing the possibility that compacted grain might block the discharge opening.

A method to reduce the propensity of compacted grain to at least partially block a discharge opening of a grain bin is additionally disclosed. The method can be useful when a sweep auger is provided in the grain bin to move grain toward the discharge opening. The method includes configuring an upper boundary structure to break up compacted grain flowing through the upper boundary structure, or to move compacted grain that does not flow through the upper boundary structure toward an outer peripheral edge of the upper boundary structure, or to both break up compacted grain flowing through the upper boundary structure and to move compacted grain resisting break-up toward an outer peripheral edge of the upper boundary structure. A mounting structure can be configured to support the upper boundary structure above the discharge opening of a grain bin and above a housing of the sweep auger.

A method for use with a sweep auger to facilitate the delivery of grain to a discharge opening of a grain bin is further disclosed. The method can include configuring a guard to include an upper boundary structure comprising a plurality of upwardly facing knife edges configured to break up at least some of a downward flow of compacted grain contacting the boundary structure. A sweep auger can be mounted in the grain bin to urge grain to move toward a discharge end of the sweep auger and toward the discharge opening of the grain bin. The plurality of knife edges can be positioned in spaced apart relation above the discharge end of the sweep auger and above the discharge opening of the grain bin. The guard and the sweep auger can be coupled together to cause the guard to rotate with the sweep auger above the discharge opening of the grain bin about a substantially vertical sweep axis. The sweep auger can be actuated.

Further areas of applicability of the present disclosure will become apparent from the detailed description provided hereinafter. It should be understood that the detailed description and various examples, while indicating various embodiments of the invention, are intended for purposes of illustration only and are not intended to limit the scope of the following claims.

### BRIEF DESCRIPTION OF THE FIGURES

The skilled artisan will understand that the drawings, described below, are for illustration purposes only. The drawings are not intended to limit the scope of the present teachings in any way.

FIG. 1 is an isometric view, partially broken away of a bin equipped with a grain bin discharge guard and power sweep assembly according to the present teachings;

FIG. 2 is a front perspective view of the guard and power sweep assembly of FIG. 1;

FIG. 3 is a side perspective view of the guard and sweep assembly of FIG. 1;

FIG. 4 is a rear perspective view of a mounting bracket disposed between the guard and a sweep motor housing;

FIG. 5 is a top perspective view of the guard and sweep assembly of FIG. 1 shown at the sweep motor housing;

FIG. 6 is a top perspective view of the guard and sweep assembly of FIG. 1 shown at the sweep portion;

FIG. 7 is a perspective view of the guard and sweep assembly shown rotated to a second position;

FIG. 8 is a perspective view of a first mounting bracket of the guard and sweep assembly;

FIG. 9 is a perspective view of a second mounting bracket illustrated in FIG. 4 of the guard and sweep assembly; and

FIG. 10 is an exemplary fastener assembly used to couple the brackets between the guard portion and the sweep portion.

### DETAILED DESCRIPTION OF VARIOUS EMBODIMENTS

Aspects of the present teachings may be further understood in light of the following examples, which should not be construed as limiting the scope of the present teachings in any way.

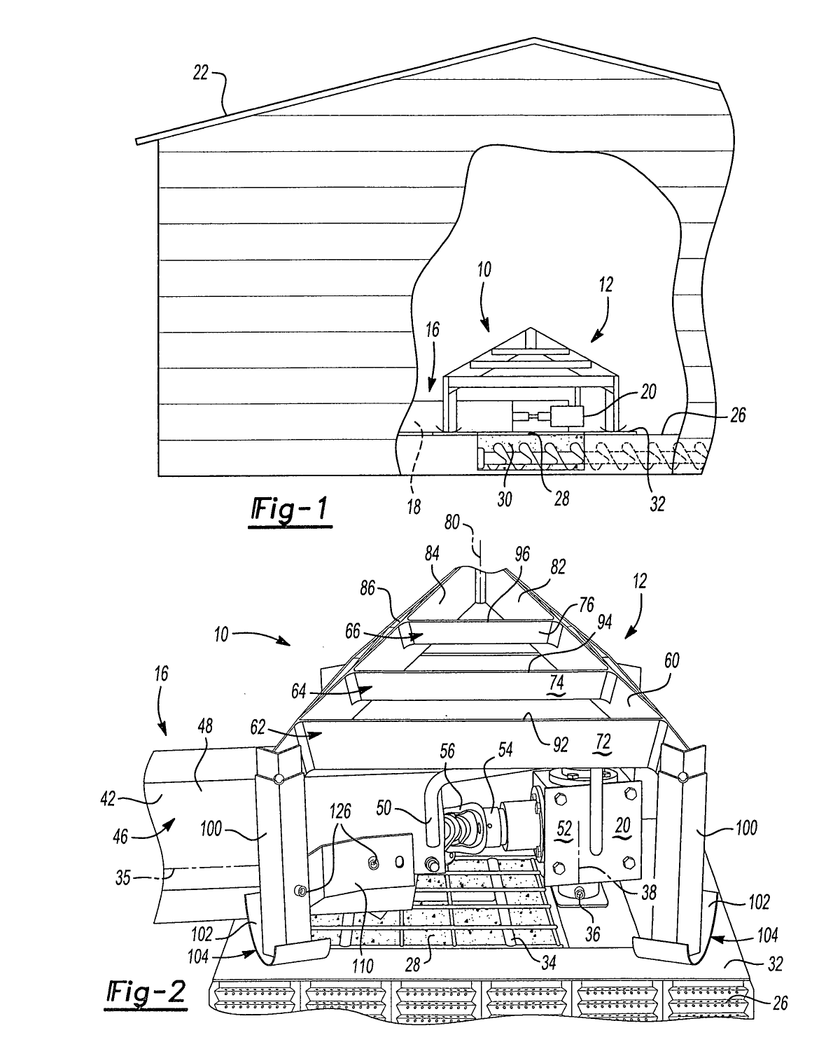

Turning now to the drawings, and initially to FIG. 1, a guard sweep assembly is shown and generally identified at reference 10. The guard sweep assembly 10 generally includes a guard portion 12 operably interconnected with a dynamic sweep portion 16. The sweep portion 16 generally includes a sweep auger 18 that is driven by a drive unit which can be sweep motor 20 above the floor 26 of the grain storage bin 22. The guard sweep assembly 10 is disposed in an operative position within a grain storage bin 22. The storage bin 22 may take the form of a covered shelter having a generally circular shape, or horizontal cross section. The storage bin 22 includes a bottom floor 26 having a centrally located discharge opening 28. Beneath the discharge opening 28 there is provided a sump or center well 30. Within the center well 30 there is disposed a conveyor auger 32 which may be driven by a suitable motor (not shown).

When grain within the storage bin 22 is to be removed therefrom, the conveyor auger 32 under the floor 26 can be rotated by a suitable motor (not shown). As any grain is removed from the center well 30, additional grain within the bin 22 flows through the opening 28 by gravity feed into the center well 30. A grate 34 (FIG. 2) may be positioned across the opening 28. For example, the grate 34 may be securably coupled to the bin floor 26 at the opening 28. Thus, the grate 34 can essentially be a part of the floor 26. The additional grain flowing into the opening 28 through the grate 34 may then be received by the conveyor auger 32 under the floor 26 and conveyed to a point of utilization external to the grain bin 22.

As described above, grain may be stored within the bin 22 for a considerable length of time. The grain, near the opening 28, under the compacting force of grain above it, can form large chunks of compacted grain. In some instances, these chunks can bridge across the opening 28. The bridging over the opening 28 by this compacted grain can impede or totally prevent the grain from flowing freely from the bin 22, through the discharge opening 28 and then into the center well 30 for conveyance by the auger 32.

To preclude such blockage of the discharge opening 28 by the compacted grain, the guard portion 12 is disposed above the discharge opening 28. This guard portion can be provided instead of the grate 34 or in addition to the grate 34. As will be described in more detail herein, the guard portion 12 can have an upper boundary structure configured to cut or break up the compacted grain chunks which may have been formed during the storage thereof and which compacted grain chunks contact the upper boundary structure. As a result, the potential for blockage of the discharge opening 28 is reduced and the free flow of grain therethrough is increased during removal of the grain from the storage bin 22. The guard portion 12 can also have an upper boundary structure that is angled or slanted in relation to the floor 26. This can result in compacted grain chunks being moved away from the discharge opening 28 as they move under gravity toward the floor 26.

As will be described in greater detail herein, the guard portion 12 can be adapted to rotate concurrently with the sweep portion 16 as the sweep auger 18 sweeps the bin floor 26. In this way, when an operator wants to perform a sweep of the bin floor 26, the sweep motor 20 is actuated. With reference to FIG. 2, the sweep motor 20 rotatably drives the sweep auger 18 about an generally horizontal auger axis 35 to draw grain across the floor 26 of the bin 22 to the opening 28. Concurrently, the guard sweep assembly 10 can be adapted to rotate with the sweep portion 16 about a drive shaft 36 defining a generally vertical drive axis 38. This action allows the sweep portion 16 to capture and draw grain from a circumference of the floor 26, which can be substantially circular. This pivot point can be located at the periphery of the discharge opening 28, or alternatively, the pivot point can be centrally located in the discharge opening 28.

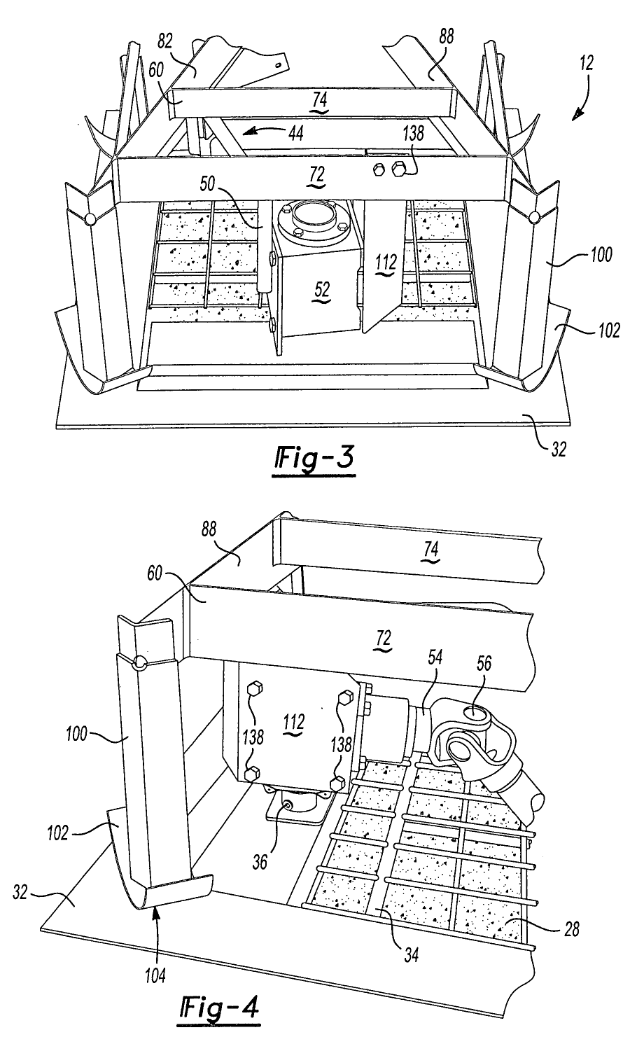

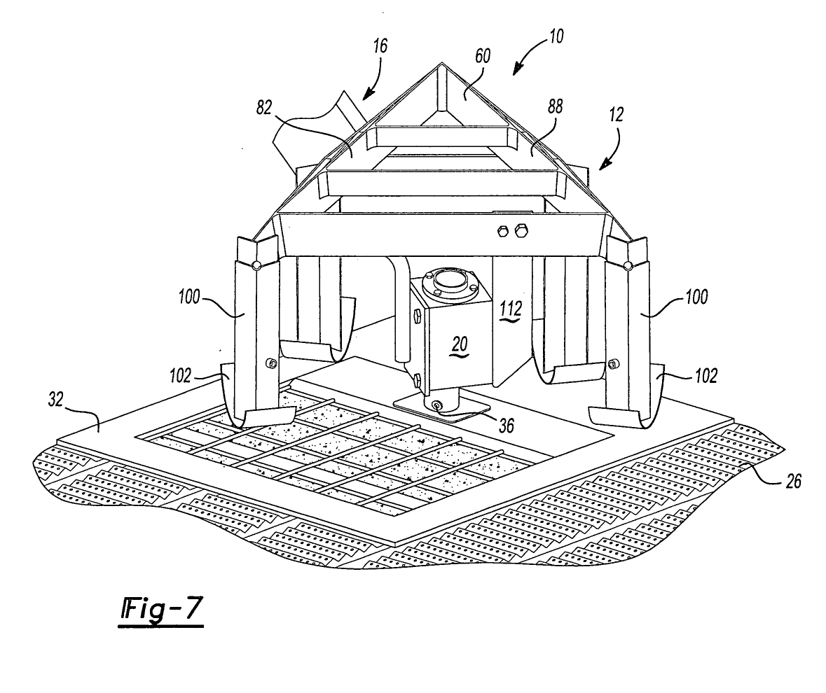

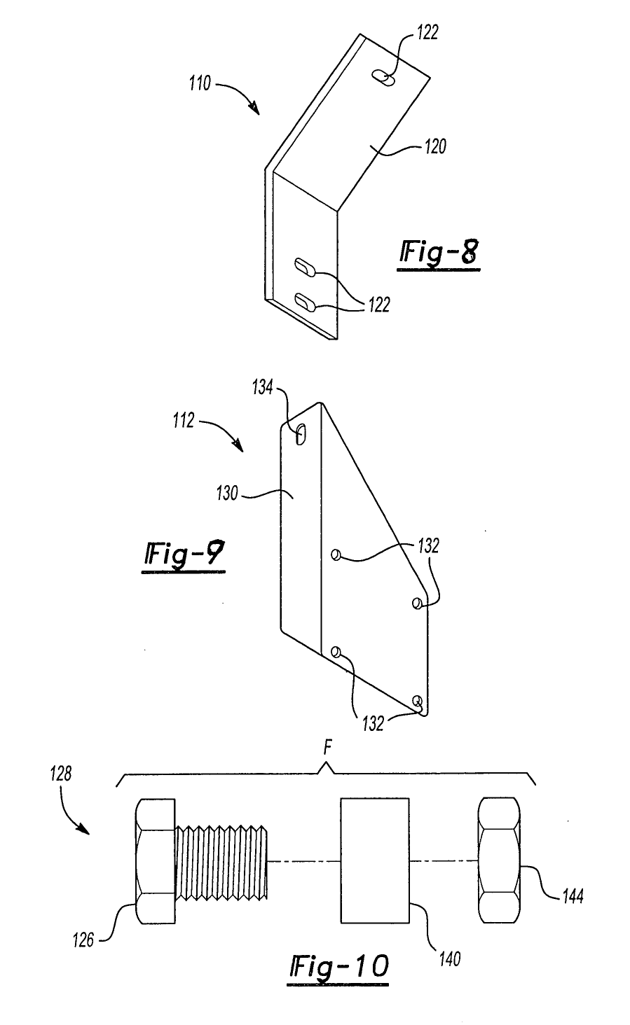

With particular reference now to FIGS. 1-4, the sweep portion 16 will be described in greater detail. The sweep portion 16 includes the sweep auger 18 rotatably mounted on the floor 26 and about the auger axis 35 with a longitudinal housing 42. The sweep auger 18 is oriented substantially horizontally. The housing 42 may generally provide an access side 44 (FIG. 3) and a scoop side 46. As can be appreciated, the sweep portion 16 rotates in a direction toward the access side 44 (clockwise about the drive axis 38 as viewed in FIG. 2), to urge the grain into engagement with the sweep auger 18. The scoop side 46 provides a containment wall 48 to urge the grain toward the sweep auger 18. The housing 42 can also include an angled top or cover adjacent the scoop side 46 above the sweep auger 18. For example, as seen in FIG. 7, angled top or cover can be formed of two sloped surfaces meeting at a peak. This top or cover can support the weight of any grain in the grain bin 22 above the sweep auger 18, which can enable proper operation of the sweep auger 18.

A support rod 50 is operably coupled between the housing 42 of the sweep auger 18 and a drive unit or motor housing 52 of the sweep motor 20. The sweep motor 20 may include an output shaft 54 that is rotatably coupled to the sweep auger 18 at a joint 56. As described, the drive axis 38 is defined by the drive shaft 36 extending above the floor 26 and coupled to the sweep motor 20. In one example, the drive shaft 36 may be driven by the sweep motor 20. In another example, the drive shaft 36 may be driven by an auxiliary motor (not shown) beneath the floor 26.

With reference now to FIGS. 2-4, the guard portion 12 will be described in greater detail. The guard portion 12 includes a guard 60. The guard 60 includes an upper boundary surface formed, in this example, by a plurality of knife units 62, 64 and 66. Each of the knife units 62, 64 and 66 can include a plurality of blades with knife unit 62 including blades 72, knife unit 64 including blades 74, and knife unit 66 including blades 76. As is best illustrated in FIG. 2, the plurality of blades 72, 74 and 76 can form knife edges. Although the term “knife” is used herein, the knife edges can be flat, rounded or peaked edge portions. In addition, although the knife edges are illustrated herein as being elongate, they may alternatively, be curved or some other shape. The blades 72, 74 and 76 can be spaced apart and disposed generally across the discharge opening 28 above the center well 30. The knife blades 72, 74 and 76 which form the knife units 62, 64 and 66 respectively, can each define a closed perimeter or periphery. In one example, the knife units 62, 64 and 66 can form square closed perimeters substantially in correspondence to the perimeter of the discharge opening 28 when the guard sweep assembly 10 is in the position shown in FIG. 2.

According to one example, the blades 72, 74 and 76 can define perimeters of increasing dimension and can be further concentrically arranged with respect to each other and with respect to a center axis 80. In this way, the blades 72, 74 and 76 of the respective knife units 62,64 and 66 can be spaced apart for breaking up the grain chunks to a sufficiently small size so as to be readily handled by the auger 32. The knife units 62, 64 and 66 are further disposed in fixed relation to one another by being fixed to inclined cross members 82, 84, 86 and 88. These connections can be made by fasteners such as a plurality of nuts and bolts, weldments, or the like. Therefore, an upper boundary structure is formed from the knife units 62, 64 and 66 which are assembled in a unitary and rigid relation to maintain their relative positions notwithstanding the substantial loading by the grain.

The blades 72, 74 and 76 may extend substantially perpendicularly to the discharge opening 28 by an extent giving each blade 72, 74 and 76 an axial width to provide further rigidity. The blades 72, 74 and 76 include upper edges 92, 94 and 96 respectively forming grain engaging cutting edges. As result of the foregoing, when grain is to be removed from the storage bin 22 through the discharge opening 28, the cutting edges 92, 94 and 96 of the blades 72, 74 and 76, respectively, will engage and cut chunks of compacted grain that might have been formed during the storage thereof to thereby break up such chunks to sufficiently small sizes to assure free flow of grain through the discharge opening 28.

The knife units 62, 64 and 66 can be arranged in a pyramid array with the blades 72, 74 and 76 and their cutting edges 92, 94 and 96 being axially spaced apart with the cutting edges 92, 94 and 96 of each respective knife unit 62, 64 and 66 being in a common plane. In the example shown, the cutting edges 92, 94 and 96 of the knife units 62, 64 and 66 are progressively spaced from the discharge opening 28 with the innermost knife unit 66 and its blade cutting edges 96 being furthest from the discharge opening 28. As a result of this configuration, any grain chunks which engage the guard 60 at an angle to the blades 72, 74 and 76 which can preclude cutting thereof by the blades 72, 74 and 76 can be directed downwardly and away from the discharge opening 28, so it will not be permitted to bridge across the blades 72, 74 and 76 themselves. Alternatively, the grain chunks may be engaged and held above the opening 28 in such a manner as to permit grain to continue flowing into the opening 28 through the sides and underneath the knife blades 72, 74 and 76.

A plurality of legs 100 may extend downwardly from the guard 60. Explained further, a plurality of legs 100 may be coupled at first ends to the inclined cross members 82, 84, 86 and 88 and at second ends to skis 102. The skis 102 may generally define an arcuate contour providing an arcuate engaging surface and may be adapted to slidably traverse across the floor 26 during operation of the guard sweep assembly 10.

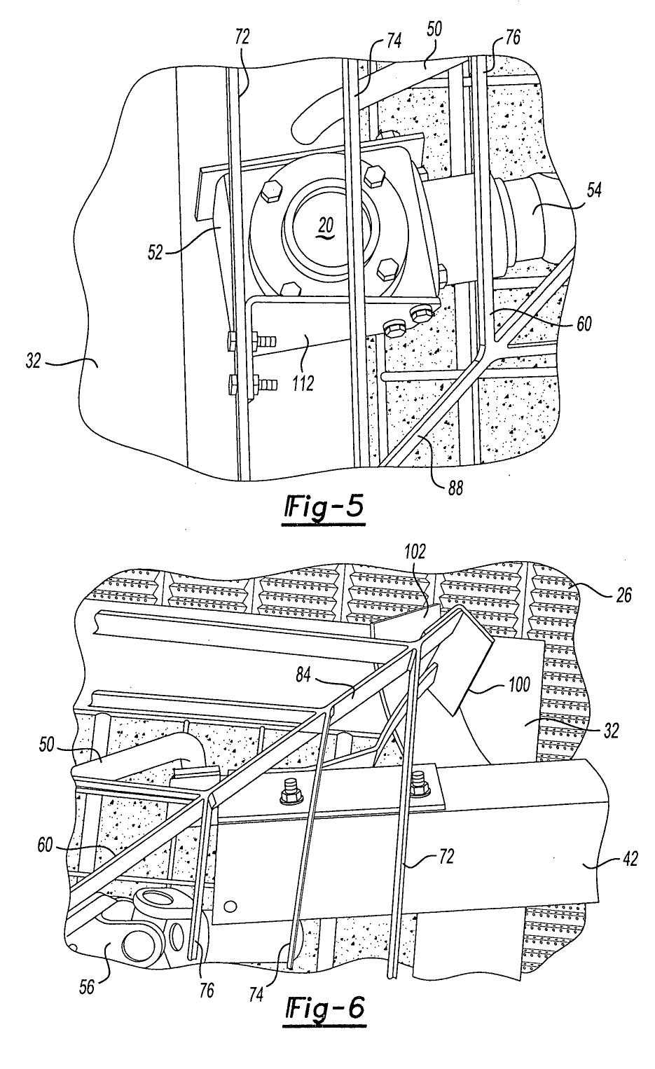

The interconnection between the guard portion 12 and the sweep portion 16 will now be described according to one example. As explained above, the guard portion 12 and the sweep portion 16 can be coupled together for concurrent rotation about the drive axis 38. A pair of brackets 110 and 112 may operably couple the guard portion 12 to the sweep portion 16. Specifically, a first bracket 110 can be coupled on a first end to a leg 100 and on a second end to the sweep auger housing 42 (FIGS. 2 and 6). The first bracket 110 may generally form an L-shape body 120 having slotted passages 122 formed thereon (FIG. 8). The slotted passages 122 can allow vertical tolerance for respective fasteners 126 (FIG. 2). The second bracket 112 may be coupled on a first end to a leg 100 and on a second end to blade 72 (FIGS. 3-5). The second bracket 112 may generally form an L-shape body 130 having passages 132 formed thereon. A slotted passage 134 can also be formed thereon. Fasteners 138 may be used to couple the second bracket 112 to the guard 60 and the sweep motor housing 52.

In one example, the guard 60 may be permitted to move slightly upward and downward as the skis 102 traverse across the floor 26. By way of example, a fastener assembly F is shown in FIG. 10. The fastener F can include the fastener 126, (or 138), a bushing 140 and a nut 144. When assembled, the fastener 138 (FIG. 3) may ride along the slot 134 formed through the bracket 112. The bushing 140 may be utilized to provide the surfaces against which the fastener 126 and nut 144 compress and allow sliding action along the slot 134. The slots 122 formed on the bracket 110 may accept a similar fastener arrangement wherein a bushing 140 may permit sliding action of the fastener 126 along the slots 122. It is appreciated that the configuration and implementation of the respective brackets 110 and 112 is merely exemplary. In this way, some slight movement between the guard portion 12 and the sweep portion is can be provided. Of course, other bracket and/or configurations may be implemented for coupling the guide portion 12 and the sweep portion 16.

As described above, the guard portion 12 and the sweep portion 16 can be coupled together for concurrent movement or sweeping rotation. As such, when it is desired to totally empty the storage bin 22, the sweep portion 16 is operated. In the exemplary illustrations, the sweep motor 20 is adapted to rotate the sweep auger 18 about its axis 35 and also impart clockwise rotation of the guard sweep assembly 10 about the drive axis 38. As viewed in FIG. 2, the guard sweep assembly 10 is shown in a first position. As viewed from FIG. 7, the guard sweep assembly 10 is shown rotated clockwise about the drive axis 38 to a second position. As can be appreciated, during rotation of the guard 60, the skis 102 are operable to navigate over the floor 26 of the grain bin 22. In this way, the arcuate engagement surfaces 104 of the skis 102 can facilitate smooth transition between the floor 26 and the grate 34. Further, the arcuate engagement surfaces 104 of the skis 102 promote unimpeded navigation over and around any grain still remaining in the grain bin 22 during sweeping.

The guard sweep assembly 10 according to the present disclosure combines the anti-blockage characteristics of the guard portion 12 with the sweep features of the sweep portion 16 in one unit. As a result, an operator does not have to remove a guard 60 from the grain bin 22 and subsequently introduce a separate sweep mechanism. Further, the guard sweep assembly 10 as a whole encourages flow of grain to the discharge opening 28 throughout normal gravity fed operation and sweep operation without interruption by operator manipulation of the structure.

It is appreciated, that in some radial positions of operation, one or more skis 102 may be off the grate 34 (see FIG. 7 for example). It is further appreciated that because the drive axis 38 may not be centered relative to the opening 28, the discharge area of the sweep portion 16 or the upper boundary surface of the guard 60 may not necessarily be located directly above the opening 28 or remain directly above the discharge opening 28 all of the time. Nonetheless, the sweeping action of the sweep portion 16 and the rotatable motion of the sweep auger 18 can cooperate to deliver a substantial portion of the grain toward and into the opening 28. Similarly, the upper boundary surface of the guard 60 can be located and remain directly above the discharge opening 28 so that its outer periphery substantially encompasses the outer periphery of the discharge opening 28, or it can always or sometimes be slightly offset therefrom.

While this invention has been described in connection with particular examples thereof, the true scope of the invention should not be so limited. For example, while the present disclosure is specifically directed toward a square-shaped discharge opening in combination with a square-shaped guard, the teachings herein are applicable to other shapes and combinations thereof. Furthermore, other modifications will become apparent to the skilled practitioner upon a study of the drawings, the specification and the following claims.

What is claimed is:

1. An apparatus for use in association with a discharge opening that is centrally located in a circular floor of a grain bin, the apparatus comprising:
a sweep auger configured to be rotatably driven about an auger axis that is substantially horizontal when the sweep auger is arranged substantially parallel and proximate to a floor of the grain bin, wherein rotation of the auger about the auger axis urges grain to move toward the discharge opening, the sweep auger further being configured to be rotatably driven about a substantially vertical sweep axis proximate to the discharge opening; and
a guard having an upper boundary structure, the guard being configured to position the upper boundary structure above the discharge end of the sweep auger and above the discharge opening of the grain bin, the upper boundary structure being configured to restrict a generally downward flow of compacted grain to the discharge opening of the grain bin, thereby reducing the possibility that compacted grain might block the discharge opening.

2. The apparatus according to claim 1, wherein the upper boundary structure has an outer periphery which is substantially equal to or greater than an outer periphery of the discharge opening, thereby the upper boundary structure at least substantially covers the discharge opening when the upper boundary structure is aligned directly above the discharge opening.

3. The apparatus according to claim 1, wherein the upper boundary structure comprises an outer periphery that is lower than another part of the boundary structure so that the upper boundary structure is configured to direct at least some of a downward flow of compacted grain to the outer periphery of the upper boundary structure, thereby reducing the possibility that compacted grain might block the discharge opening.

4. The apparatus according to claim 1, wherein the upper boundary structure comprises a plurality of spaced apart knife edges configured to break up at least some of a downward flow of compacted grain contacting the boundary structure as the compacted grain moves to the discharge opening, thereby reducing the possibility that compacted grain might block the discharge opening.

5. The apparatus according to claim 4, wherein the plurality of spaced apart knife edges comprise at least one knife edge located near an outer periphery of the upper boundary structure and at least one other knife edge located laterally adjacent to the at least one knife edge and above the at least one knife edge, the upper boundary structure thereby being configured to break up at least some of a downward flow of compacted grain contacting the boundary structure and to move away from the discharge opening at least some of the downward flow of compacted grain contacting the boundary structure.

6. The apparatus according to claim 1, wherein the sweep auger comprises a housing with an elongated cover extending along the auger axis, and the upper boundary structure has a first major dimension that is no more than 2 times a second major dimension, the second major dimension being perpendicular to the first major dimension;
wherein the apparatus further comprises a mounting assembly coupling a housing of the sweep auger to the guard, the mounting assembly including at least one bracket with an elongated aperture therein, a bushing extending through the elongated aperture, and a fastener including a head, the fastener extending through the bushing to space the head away from the bracket, thereby permitting limited movement of the sweep auger and the guard relative to each other;
wherein the guard further comprises a plurality of supports which extend from the upper boundary surface to the floor to support the upper boundary structure above the floor of the grain bin, the plurality of supports comprising skids configured to slide across the floor of the grain bin as the sweep auger rotates about the discharge opening;
at least one relatively low set of elongate blades at a periphery of the upper boundary structure above an outer periphery of the discharge opening, at least one relatively high set of elongate blades located at a central part of the upper boundary structure and at least one intermediate set of elongate blades located laterally between and at an intermediate vertical height between the at least one relatively low set of elongate blades and the at least one relatively high set of elongate blades;
the guard configured to be coupled to the sweep auger to cause the guard and the sweep auger to rotate concurrently about the substantially vertical sweep axis;
wherein the upper boundary structure has an outer periphery which is substantially equal to or greater than the outer periphery of the discharge opening, thereby the upper boundary structure at least substantially covers the discharge opening when the upper boundary structure is aligned directly above the discharge opening;
wherein the plurality of supports are legs; and
further comprising a grate covering the discharge opening.

7. An apparatus for moving grain in a grain bin to a discharge opening that is centrally located in a circular floor of the grain bin, the apparatus comprising:
a sweep auger arranged substantially parallel and proximate to a floor of the grain bin, the sweep auger being rotatably driven about an auger axis, the auger axis being substantially horizontal, wherein rotation of the sweep auger about the auger axis urges grain to move toward the discharge opening, the sweep auger further being rotatably driven about a sweep axis proximate to the discharge opening, the sweep axis being substantially vertical; and
a guard coupled to the sweep auger to cause the guard and the sweep auger to rotate concurrently about the substantially vertical sweep axis, the guard having an upper boundary structure, the upper boundary structure being positioned above the discharge end of the sweep auger and above the discharge opening of the grain bin, the upper boundary structure comprising a plurality of knife edges to break up at least some of a downward flow of compacted grain contacting the boundary structure as compacted grain moves to the discharge opening, thereby reducing the possibility that compacted grain might block the discharge opening.

8. The apparatus according to claim 7, wherein the plurality of spaced apart knife edges comprise a plurality of first knife edges located near the outer periphery of the upper boundary structure and a plurality of second knife edges located laterally adjacent to the first knife edges and above the first knife edges.

9. The apparatus according to claim 8, wherein the plurality of spaced apart knife edges further comprise a plurality of third knife edges located laterally between and at an intermediate height between the first and second knife edges, and the plurality of knife edges are joined by a plurality of elongate members sloping between the plurality of spaced apart knife edges.

10. The apparatus according to claim 7, wherein the upper boundary structure has an outer periphery which is substantially equal to or greater than an outer periphery of the discharge opening, thereby the upper boundary structure at least substantially covers the discharge opening when the upper boundary structure is aligned directly above the discharge opening.

11. The apparatus according to claim 7, wherein the apparatus further comprises a mounting assembly coupling the sweep auger to the guard, the mounting assembly including at least one bracket with an elongated aperture therein and a fastener including a shank and a head, the shank extending through the elongated aperture and the head positioned to retain the at least one bracket while permitting movement between the fastener and the at least one bracket.

12. The apparatus according to claim 7, wherein the guard further comprising a plurality of supports extending from the upper boundary structure to the floor to support the upper boundary structure above the floor of the grain bin, the supports comprising skids configured to slide across the floor of the grain bin as the sweep auger rotates about the discharge opening.

13. The apparatus according to claim 11, wherein the guard further comprising a plurality of supports extending from the upper boundary surface to the floor to support the upper boundary structure above the floor of the grain bin, the supports comprising skids configured to slide across the floor of the grain bin as the sweep auger rotates about the discharge opening; and wherein the at least one bracket comprises a first bracket that couples an elongate housing of the sweep auger and one of the plurality of supports and a second bracket that couples a drive unit housing to a blade associated with one of the plurality of knife edges.

14. The apparatus according to claim 13, wherein the sweep axis is offset from a central point of the discharge opening,
wherein the plurality of spaced apart knife edges comprises a plurality of first knife edges located near the outer periphery of the upper boundary structure, a plurality of second knife edges located laterally adjacent to the first knife edges and above the first knife edges, and a plurality of third knife edges located laterally between and at an intermediate height between the plurality of first and second knife edges, and the plurality of knife edges are joined by a plurality of elongate members sloping between the plurality of spaced apart knife edges so that the upper boundary structure has a square pyramid shape;
wherein the upper boundary structure has an outer periphery which is substantially equal to or greater than the outer periphery of the discharge opening, thereby the upper boundary structure at least substantially covers the discharge opening when the upper boundary structure is aligned directly above the discharge opening;
further comprising a grate covering the discharge opening; and
wherein the plurality of supports are legs.

15. A method to reduce the propensity of compacted grain to at least partially block a discharge opening of a grain bin, wherein a sweep auger is provided in the grain bin to move grain toward the discharge opening, the method comprising:
configuring an upper boundary structure to break up compacted grain flowing through the upper boundary structure, or to move compacted grain that does not flow through the upper boundary structure toward an outer peripheral edge of the upper boundary structure, or to both break up compacted grain flowing through the upper boundary structure and to move compacted grain resisting break-up toward an outer peripheral edge of the upper boundary structure;
configuring a mounting assembly to support the upper boundary structure above the discharge opening of a grain bin and above a housing of the sweep auger.

16. The method according to claim 15, wherein configuring the mounting assembly further comprises configuring the mounting assembly to couple the upper boundary structure to the sweep auger to cause the upper boundary surface to rotate concurrently with the sweep auger about a vertical sweep axis of the sweep auger.

17. The method according to claim 16, further comprising configuring the mounting assembly to permit limited movement of the upper boundary structure relative to the sweep auger.

18. The method according to claim 16, further comprising providing at least one bracket configured to couple the guard to the sweep auger in a position proximate to the discharge opening, the at least one bracket being part of the mounting assembly.

19. The method according to claim 15, wherein configuring the upper boundary structure comprises configuring the upper boundary structure to break up compacted grain flowing through the upper boundary structure, or to both break up compacted grain flowing through the upper boundary structure and to move compacted grain resisting break-up toward an outer peripheral edge of the upper boundary structure;
wherein configuring the mounting assembly further comprises configuring the mounting assembly to couple the upper boundary structure to the sweep auger to cause the upper boundary surface to rotate concurrently with the sweep auger about a vertical sweep axis of the sweep auger;
wherein configuring an upper boundary structure further comprises providing the upper boundary structure with a periphery which is substantially equal to or greater than an outer periphery of the discharge opening, thereby the upper boundary structure at least substantially covers the discharge opening when the upper boundary structure is aligned directly above the discharge opening;
wherein configuring a mounting assembly further comprises configuring a plurality of supports to slide across a floor of the grain bin;
further comprising configuring the mounting assembly to permit limited movement of the upper boundary structure relative to the sweep auger;
wherein configuring a mounting assembly further comprises providing at least one bracket to couple the sweep auger and the upper boundary structure together; and
further comprising providing a grate across the discharge opening.

20. A method for use with a sweep auger to facilitate the delivery of grain to a discharge opening of a grain bin, the method comprising:
configuring a guard to include an upper boundary structure comprising a plurality of upwardly facing knife edges configured to break up at least some of a downward flow of compacted grain contacting the boundary structure;
mounting a sweep auger in the grain bin to urge grain to move toward a discharge end of the sweep auger and toward the discharge opening of the grain bin; and
positioning the plurality of knife edges in spaced apart relation above the discharge end of the sweep auger and above the discharge opening of the grain bin;
coupling the guard and the sweep auger together to cause the guard to rotate with the sweep auger above the discharge opening of the grain bin about a substantially vertical sweep axis; and
actuating the sweep auger.

21. The method according to claim 20, wherein configuring the guard comprises a providing a first plurality of upwardly facing knife edges near the outer periphery of the upper boundary structure, providing a second plurality of upwardly facing knife edges laterally adjacent to the first plurality of upwardly facing knife edges and above the first plurality of upwardly facing knife edges, providing a third plurality of upwardly facing knife edges laterally between and at an intermediate height between the first and second plurality of upwardly facing knife edges, and coupling the plurality of upwardly facing knife edges together with a plurality of elongate members sloping between the first, second and third plurality of upwardly facing knife edges.

22. The method according to claim 20, further comprising configuring the upper boundary structure to have an outer periphery which is substantially equal to or greater than an outer periphery of the discharge opening, thereby the upper boundary structure at least substantially covers the discharge opening when the upper boundary structure is aligned directly above the discharge opening.

23. The method according to claim 20, further comprising using a mounting assembly to couple the sweep auger to the guard, the mounting assembly including at least one bracket with an elongated aperture therein and a fastener including a shank and a head, the shank extending through the elongated aperture and the head positioned to retain the at least one bracket while permitting movement between the fastener and the at least one bracket.

24. The method according to claim 23, further comprising providing the guard with a plurality of supports which extend from the upper boundary surface to the floor to support the upper boundary structure above the floor of the grain bin, and providing the supports with skids configured to slide across the floor of the grain bin as the sweep auger rotates about the discharge opening; and coupling the at least one bracket between an elongate housing of the sweep auger and one of the plurality of supports and coupling a second bracket between a drive unit housing and a blade associated with one of the plurality of knife edges.

25. The method according to claim 24, wherein configuring the guard comprises providing a first plurality of upwardly facing knife edges near the outer periphery of the upper boundary structure, providing a second plurality of upwardly facing knife edges laterally adjacent to the first plurality of upwardly facing knife edges and above the first plurality of upwardly facing knife edges, providing a third plurality of upwardly facing knife edges laterally between and at an intermediate height between the first and second plurality of upwardly facing knife edges, and coupling the first, second, and third plurality of upwardly facing knife edges together with a plurality of elongate members sloping between the first, second and third plurality of upwardly facing knife edges so that the upper boundary structure has a square pyramid shape;
further comprising configuring the upper boundary structure to have an outer periphery which is substantially equal to or greater than an outer periphery of the discharge opening, thereby the upper boundary structure at least substantially covers the discharge opening when the upper boundary structure is aligned directly above the discharge opening;
further comprising providing a grate to cover the discharge opening;
and further comprising providing the plurality of supports as legs.
